(19) United States
(12) Patent Application Publication
(10) Pub. No.: US 2004/0028863 A1
(43) Pub. Date: Feb. 12, 2004

(54) Bonding system for pipe insulation

(76) Inventor: Michelle B. Shamer, Wake Forest, NC (US)

Correspondence Address: Melvin I Stoltz, 51 Cherry Street, Molford, CT, 06460, US

(21) Appl. No.: 10/398,176

(22) PCT Filed: Oct. 3, 2001
(86) PCT No.: PCT/US01/30988

(51) Int. Cl. B32B 9/00

(52) U.S. Cl. 428/40.1; 428/354

(57) ABSTRACT

By providing an intermediate substrate (30), which has been treated with an adhesion promoter (31), as an integral component of the sealing system of a plastic product or an elongated, slit, thermoplastic or elastomeric tube (23), a cohesive bond is achieved in the sealing system which virtually eliminates opening of the plastic product or thermoplastic or elastomeric tube (23) without degradation of the material itself. The adhesion promoting agent (31) may comprise of a treatment for the intermediate substrate (30) or may comprise of a separate layer affixed to the substrate (30). As a result, a highly effective, easily employed, self-sealing closure/surement system for securely affixing two surfaces (21, 22) to each other is attained.

### TECHNICAL FIELD

This invention relates to closure, locking, or securement systems for numerous products having one surface to be secured to another surface and, more particularly, to elongated, thermoplastic or elastomeric tubes formed for peripherally surrounding elongated pipes, poles, support rods and the like wherein the closure system is intimately bonded to the tube and is easily sealable for securely mounting the tube about the pipe, rods, or poles.

### BACKGROUND ART

With the ever-increasing variety of products being produced for consumer use and comfort, numerous areas have been developed in which the secure mounting of two surfaces together has become increasingly important. Although these areas are widely diverse, one important area is found in the need to secure foam tubes about pipes, poles, support rods, and the like.

In one area, foam tubes are employed as cushioning means to surround and protect pipes, poles, rods, etc., such as found with play equipment. By employing these tube members, the otherwise hard metal surface is protected and effectively converted into a soft, cushioned surface for preventing injuries.

Another important area is found with surrounding hot and cold pipes. With the ever increasing importance being placed upon energy conservation, as well as the skyrocketing cost of fuel for heating and cooling, an increasing number of domestic and commercial heating and cooling systems are being insulated, in order to reduce or eliminate temperature losses occurring along the pipes which carry heating or cooling fluid. In particular, in conventional hot water delivery and heating installations, hot water is carried through elongated pipes, which are mounted in basements or unheated plenums.

It has been found that a substantial amount of heat loss is experienced through the walls of the pipes due to radiation through the walls of the pipe into the lower temperature basement or plenum. In order to virtually eliminate or substantially reduce this considerable energy loss, insulation has been wrapped around the pipe. In addition, the insulation of pipes also virtually eliminates condensation on the outer surfaces of the pipes, as well as pipe corrosion, particularly in underground installations.

The most popular insulation systems comprise wrapping fiberglass around the elongated pipes, or installing elongated, pre-cut cylindrically shaped tubes of elastomeric or thermoplastic material. Due to the ease of installation and handling, the pre-slit thermoplastic or elastomeric insulating tubes have become extremely popular.

In order to install these insulating tubes, the tube is merely opened along the longitudinally extending slit formed therein and extending the entire length of the tube. In this way, the insulating tube is quickly and easily positioned about the fluid carrying conduit, providing the desired insulation thereto. In addition, pipe bends or other junctions are easily handled by merely cutting the tubes to the appropriate shape in order to meet with the adjacent insulation material.

In order to properly install the pre-slit, elongated insulating tubes, the longitudinally extending tube must be sealed to prevent unwanted heat loss or water seepage through the slit. It is this requirement for sealing the tube which has caused the greatest challenges.

Some prior art systems incorporate external means, such as tape, glue, clips, or cement to provide the desired adhesion between the slit surfaces. However, these systems are difficult to work with, due to the cumbersome nature of installing the external adhesive or fastening means, as well as the difficulty in assuring that the entire slit has been sealed and that no open zones have been left. Complete sealing is extremely important, since open zones allow temperature losses, or access for moisture to reach the pipes, thereby reducing the effectiveness of the insulation.

One of the principal difficulties encountered with prior art tape, cement and glue sealing systems is the inability of the slit to be completely sealed 100% of the time. As a result, leaks occur, resulting in heat loss.

Prior art tape systems, whether separately applied or integrally formed with the tube, are incapable of being securely affixed to the surface of the foam tube, due to the physical construction of the tube's surface. Consequently, these prior art tape sealing systems tend to peel off of the tube, causing the tube to open. In addition, these tape systems are extremely expensive and add additional labor costs.

Cement or glue is also widely used in the industry but is inherently labor-intensive, time-consuming and messy in nature. Furthermore, the glue or cement material and application must be separately purchased and brought to each site for use.

In an attempt to satisfy the needs of the industry, self-sealing systems have been developed. These self-sealing systems include pressure sensitive adhesive strips affixed to the tube along one or both side edges of the slit or adjacent the slit and an elongated tongue-and-groove closure system, with the tongue-and-groove longitudinally extending along the entire length of the tube, formed in the opposed side walls of the slit. Although these constructions eliminate the need for external fasteners, tape, or cement, these systems have proven to be unable to solve all of the industry's problems.

Although these various systems exist, the two major bonding systems found in today's insulation market are pressure sensitive adhesive seams and lap seal. The pressure sensitive adhesive seams generally have a pressure sensitive adhesive adhered to both walls of a longitudinally slit insulation tube in which the pressure sensitive adhesive is protected by one or two removable release liners. The lap seal systems are insulation closure systems that are adhered by some means, such as lamination or pressure sensitive adhesive, to the exterior surface of the product. The seam is sealed by pulling the lap across the longitudinal slit and adhering it to the opposite outside surface of the insulation, which may or may not have a receiving pressure sensitive adhesive or substrate attached to the surface.

The use of a pressure sensitive adhesive bonding system is most prevalent in thermoplastic and elastomeric foam pipe insulation. Pressure sensitive adhesive systems which bond the walls of the longitudinal slit are good insulators and great vapor barriers. However, as detailed herein, due to poor installations and improperly sized or sometimes oval insulation, unforeseen stresses are put on the pressure sensitive adhesive seam. These stresses, under certain conditions, will sometimes cause the seam to “creep” open. Once the seam has opened, the insulation factor is diminished and condensation is allowed to form or heat is allowed to escape. The reason that basic pressure sensitive adhesives to pressure sensitive adhesive bonded seams fail is that the bond is of an adhesive nature. Essentially, the pressure sensitive adhesives are pressed together but no mechanical or locking bond is made. Consequently, under these creep stresses, the pressure sensitive adhesive interface separates.

Lap seals are most often utilized in the fiberglass industry. It seems that the lap seal systems found in the industry today do not incorporate a pressure sensitive adhesive bond along the walls of the longitudinal slit. The probable reason for the absence of the pressure sensitive adhesive bond in these systems is economical. By not having that pressure sensitive adhesive bond under the lap seal, the insulation value can diminish and the vapor barrier can become very weak and easily overcome, especially if the FSK liner around the fiberglass gets punctured or torn. If the lack of insulating value causes a pipe to condensate, moisture will build along the longitudinal seam and cause the lap seal to be weakened to the point of failure.

Due to its ease and convenience, the most popular bonding system consists of a longitudinally slit tube with pressure sensitive adhesive applied to the side walls or edges, protected by two removable release liners. When the product is installed, the end user slides the insulation over the piping system, pulls the two release liners, and engages the seam under pressure.

Although these systems have become popular, failure normally constitutes the seam opening up, causing the insulation value to diminish and condensation to form or heat to be lost. Typical reasons for having a seam open are improper installation, improperly sized insulation, oval insulation, or poor seam construction. The two principal reasons for failures have been found to be oval-shaped insulation and inproper installation.

Sometimes inherent in the manufacture of foam tube insulation is the production of oval-shaped insulation. This is most frequently found with the production of thinner wall thicknesses with larger inside diameters, and is a common occurrence throughout the thermoplastic insulation industry.

Thermoplastic foam inherently has great memory. When oval-shaped foam is installed on perfectly round pipe, the memory of the foam tries to return it to its oval shape and stresses are placed on the seam. These stresses cause the glue seam to “creep” open. The “creep” effect causes the insulation to begin opening from the inside, which diminishes the insulation factor.

Once the insulation factor is lost, condensation can form or heat can be lost, which then accumulates in the opening seam and causes a total seam failure. This “creep” failure is the most detrimental because it is not observed until there is a complete seam failure.

Improper installation is the other leading cause of seam failure. Most insulation should be installed at a temperature greater than 35° F. Ideally, it should be installed at 70° F. The colder the ambient temperature at installation, the higher the pressure required to engage the pressure sensitive adhesives. If the installer does not apply enough pressure to totally engage the pressure sensitive adhesive, then a gap is left on the inside of the seam. Failures then occur in the same manner as the “creep” phenomenon.

Therefore, it is a principal object of the present invention to provide a closure system for elongated, thermoplastic or elastomeric tubes which is integrally affixed to the tube, is quickly and easily employed, and provides substantially enhanced, bonded engagement of the abutting side edges.

Another object of the present invention is to provide a closure system for elongated, thermoplastic or elastomeric tubes, having the characteristic features described above which provides a high degree of insulation for preventing or reducing heat loss from fluid carrying pipes or for protecting hard surfaces, which is convenient to employ, and provides a dependable, secure locking interengagement that is achieved with simplicity and ease, assuring time-efficient installation thereof.

A further object of the present invention is to provide a closure system for elongated, thermoplastic or elastomeric tubes, having the characteristic features described above, which is inexpensive to manufacture and provides a secure, dependable, trouble-free bonded interengagement with the tube, virtually eliminating unwanted peeling, dislodgement, and product creep.

Another object of the present invention is to provide a closure system for elongated, thermoplastic or elastomeric tubes, having the characteristic features described above, which allows the tubes to be quickly, easily, and inexpensively installed.

Other and more specific objects will in part be obvious and will in part appear hereinafter.

### SUMMARY OF THE INVENTION

By employing the present invention, all of the difficulties and drawbacks encountered in prior art closure, locking and securement systems have been eliminated and a highly effective, easily employed, self-sealing, closure/securement system for securely affixing two surfaces to each other is attained. In the most common application of the present invention, the sealing of a longitudinal slit of an elongated thermoplastic or elastomeric tube is attained in a manner that virtually eliminates the typical prior art failures.

In the present invention, the prior art drawbacks and difficulties are eliminated by employing a self-sealing closure system which provides a cohesive bond, as opposed to the typical adhesive bonds found in the prior art. As is well-known in the industry, cohesive bonds are substantially stronger than adhesive bonds, providing secure, affixed interengagement which, in this application, is at least six times stronger than adhesive bonds, depending on pipe temperature and pressure on the seam.

In order to achieve a cohesive bonding system, an intermediate substrate is employed, with the substrate being treated with an adhesion promoter. By incorporating the intermediate substrate which is treated with an adhesion promoter, as an integral component of the sealing system of the present invention, cohesive bonding is achieved in a sealing system which virtually eliminates opening of the thermoplastic or elastomeric tube without degradation of the material itself. As detailed herein, the adhesion promoting agent may comprise of a treatment for the intermediate substrate or may comprise of a separate layer affixed to the substrate.

In one principal application of the present invention, a desired amount of insulation is imparted to a pipe or conduit by mounting an elongated tube, in peripheral, surrounding engagement therewith. Typically, the tube is formed of substantially thick material. In this way, coverage and insulation of the fluid carrying pipe is realized and unwanted temperature loss and energy loss is prevented. Typically, the elongated tube is formed from a foamed, cellular thermoplastic or elastomeric material. One such material often employed is foamed, closed cell polyethylene. This material is cellular foamed thermoplastic material which provides a high degree of insulation for its size and weight. However, other materials with substantially equivalent characteristics may be employed without departing from the scope of this invention.

By providing a sealing system which provides cohesive bonding of the edges of the polyethylene, thermoplastic, or elastomeric foam tube, the elongated tube is effectively integrally bonded to itself. In this way, a virtual 100% adhesive interengagement is attained, and a sealing system is achieved which is incapable of being opened or removed from the tube. By employing the present invention, removal of the adhesive system is attained only by physically destroying the integrity of the elongated polyethylene, thermoplastic, or elastomeric foamed tube itself.

As discussed above, prior art closure systems have been developed which employ a pressure sensitive adhesive backed carrier tape or film which is affixed to the foam tube by contacting the adhesive layer with the foam tube. These prior art closure systems have been employed on the outside surface of the elongated foam tube spanning the elongated slit, as well as along the side edges forming the elongated slit. However, regardless of which area of the foam tube is used, these prior art systems are incapable of providing secure, creep-resistant bonded interengagement of the foam tube.

As is well known in the art, thermoplastic and elastomeric foam tube slits are comprised of extremely irregular, non-smooth surfaces which incorporate numerous depressions or craters randomly dispersed throughout the surface. This construction results in randomly located upstanding ridges or sections forming the outer peripheral surface thereof.

In view of this well-known construction, the use of pressure sensitive adhesive backed tapes or films as the means for sealing the elongated slit have proven to be ineffective, since the contact between the adhesive layer and the surface of the film is made only along the upstanding ridges or sections which form the outer surface of the foam tube. Consequently, only random point contact is realized, resulting in insufficient bonding strength to assure a consistent, long-term, uniform, securely affixed adhesion of the tape or film to the surface of the foam tube. As a result, these prior art systems generally fail to provide the desired secure sealing, and typically result in loosening or dislodgement of the tape from the tube and unwanted opening of the elongated slit.

In the present invention, all of these prior art difficulties and drawbacks have been eliminated by achieving a unique, closure system which produces cohesive bonding. In accordance with the present invention, both the resulting product and its method of application constitute the unique features of this invention.

In accordance with the present invention, various materials can be employed for use as the intermediate substrate employed in the sealing system defined herein. One material which has been found to work effectively is a polyester film. By treating the polyester film with an adhesion promoter, or applying the adhesion promoter as a separate layer affixed to the substrate, and permanently adhering the polyester film to at least one side edge of the elongated slit of the thermoplastic or elastomeric tube, a new bonding system is attained which provides mechanical cohesive bonding which is substantially greater than the adhesive bonding provided by prior art pressure sensitive adhesives.

The preferred intermediate substrates employed in the present invention are selected from materials that naturally incorporate numerous pockets or pits on its surface, or are responsive to adhesion promoting agents to form such pockets or pits. In this regard, polyester films represent one of the preferred materials to employ for the intermediate substrate.

Prior to application of the intermediate substrate to the thermoplastic or elastomeric tube, an adhesion promoter is applied as a coating on the intermediate substrate or a treatment for the intermediate substrate. The application of the adhesion promoter causes the surface energy of the substrate to increase, while the surface tension of the film is lowered. This makes the film much more receptive to bonding than other materials, such as pressure sensitive adhesives which surface energies are very low.

Once the intermediate substrate has been treated with the adhesion promoter, the substrate is ready to be secured to at least one side edge of the slit of an elongated, thermoplastic or elastomeric tube. In accordance with the present invention, it has been found that the application of the intermediate substrate to only one side edge of the slit is sufficient to provide the cohesive bonding achieved by the present invention. However, if desired, the treated intermediate substrate may be applied to both side edges of the slit of the elongated, thermoplastic or elastomeric tube.

In the preferred application and use of the bonding system of the present invention, the intermediate substrate, after being treated with the adhesion promoter, is affixed to one side edge of the elongated slit of an elongated, thermoplastic or elastomeric tube by applying a pressure sensitive adhesive to either one surface of the substrate or to the side edge of the thermoplastic or elastomeric tube. Then, the substrate is securely affixed to the side edge of the thermoplastic or elastomeric tube. Since the substrate has been treated on both sides thereof with the adhesion promoter, a cohesive bond is achieved between the intermediate substrate and the thermoplastic or elastomeric tube.

In this preferred embodiment, a pressure sensitive adhesive is applied to the opposing side edge of the slit of the thermoplastic or elastomeric tube, with the pressure sensitive adhesive being protected by a release strip or liner which prevents the adhesive from becoming actively engaged with the intermediate substrate affixed to the opposed edge of the slit, until the liner has been removed. Once the thermoplastic or elastomeric tube is installed in the precisely desired location, the liner is removed and the pressure sensitive adhesive mounted to one side edge of the longitudinal slit is brought into engagement with the intermediate substrate affixed to the opposed side edge of the longitudinal slit.

When the pressure sensitive adhesive is brought into engagement with a surface of the intermediate substrate to which the adhesion promoter has been applied, the pressure sensitive adhesive is easily forced into the pockets of the substrate, forming a mechanical, cohesive bond therebetween. This interengagement establishes a cohesive bond between the edges of the slit of the thermoplastic or elastomeric tube which is not easily separated. This bonded engagement achieves a sealing system which eliminates all of the prior art difficulties and provides the desired secure affixation of the thermoplastic or elastomeric tube in the precisely desired location, with assurance that unwanted opening of the tube is eliminated.

The invention accordingly comprises the several steps and relation of one or more such steps with respect to each of the others, and the article possessing the features, property, and relation of elements which are exemplified in the following detailed disclosure, and the scope of the invention will be indicated in the claims.

### THE DRAWINGS

For a fuller understanding of the nature and objects of the invention, reference should be had to the following detailed description taken in connection with the accompanying drawings in which:

FIG. 1 is a cross-sectional side elevation view of a slit, foam, thermoplastic or elastomeric tube incorporating the self-sealing bonding/securement system of the present invention mounted to the side edges thereof;

FIG. 2 is an enlarged cross-sectional side elevation view of Section “A” of FIG. 1;

FIG. 3 is an enlarged cross-sectional side elevation view of Section “B” of FIG. 2;

FIG. 4 is a cross-sectional side elevation view of a slit, foam, thermoplastic or elastomeric tube incorporating an alternate embodiment of the self-sealing bonding/securement system of the present invention mounted to the side edges thereof;

FIG. 5 is an enlarged cross-sectional side elevation view of Section “A” of FIG. 4; and

FIG. 6 is an enlarged cross-sectional side elevation view of Section “B” of FIG. 5.

### DETAILED DISCLOSURE

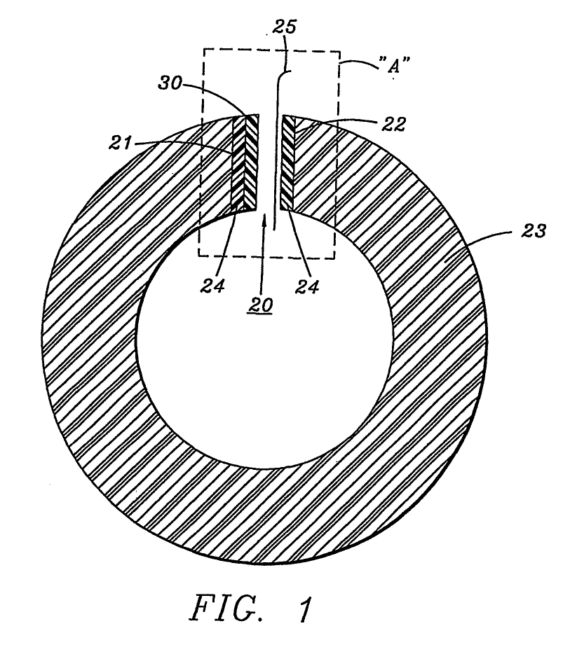

By referring to FIGS. 16, along with the following detailed discussion, the construction and operation of the preferred embodiment of the unique, self-sealing, bonding/securement system of the present invention can best be understood. As discussed above, the substantially enhanced, self-sealing, bonding/securement system of the present invention may be employed in a wide variety of products including elongated, foamed thermoplastic or elastomeric tube members, packaging, bedding products, home decoration systems, custom made foam profiles, and toys. Although the present invention has direct applicability to virtually all of these various areas and products, FIGS. 1-6 and the following detailed disclosure focus upon the use of the bonding system of the present invention in connection with pre-slit, elongated, foamed thermoplastic or elastomeric tubes.

In the following detailed disclosure and drawings, two preferred embodiments of the bonding/securement system of the present invention and one particular end use is depicted, namely the mounting of the bonding/securement system to the side edges of a pre-slit, elongated, foamed thermoplastic or elastomeric tube. However, it is to be understood that these embodiments and application are provided for illustrative purposes only. Consequently, it is intended that all alternate embodiments and product applications are included within the scope of the present invention and the embodiments detailed herein should be considered for illustrative purposes only and not as a limitation of the present invention.

As discussed above, the present invention achieves a cohesive bond between the two surfaces being secured, as opposed to the conventional adhesive bond found in prior art systems. Furthermore, although a cohesive bond is typically created either chemically or mechanically, the present invention employs both chemical and mechanical elements to achieve the resulting bond.

In the present invention, an adhesion promoting agent is applied to an intermediate substrate and, thereafter, the substrate is affixed to one of the surfaces being bonded, using a pressure sensitive adhesive. The application of the adhesion promoting agent to the intermediate substrate causes a chemical interaction with the surfaces of the substrate to create pockets or pits therein. In addition, the adhesion promoting agent may be applied as a separate layer formed on the substrate or interact with the surface of the substrate.

Thereafter, when binding or securement is desired, the two surfaces are brought together, causing the mechanical engagement of the pressure sensitive adhesive in the pockets or pits formed in the surface of the substrate and/or the adhesion promoting agent layer. Due to the application of the adhesion promoting agent, this mechanical engagement provides the desired cohesive bonding of the two surfaces.

In one preferred application of the present invention detailed herein, the self-sealing, bonding/securement system is affixed to the inside edges of a longitudinal slit formed in an elongated, foamed, thermoplastic or elastomeric tube. By providing a product which incorporates the bonding/securement system of the present invention, a resulting product is achieved which is capable of being installed in any desired location with complete assurance that unwanted opening or separation of the sealed slit will not occur.

By referring to FIGS. 1-3, along with the following detailed discussion, the construction and operation of one preferred embodiment of the self-sealing, bonding/securement system 20 of the present invention can best be understood as employed in this preferred application. As depicted, self-sealing, bonding/securement system 20 is affixed to edges 21 and 22 of elongated, foamed, thermoplastic or elastomeric tube 23. Edges 21 and 22 represent the juxtaposed, spaced, facing side edges formed in thermoplastic or elastomeric tube 23 by longitudinally slitting tube 23 to enable tube 23 to be mounted into peripheral surrounding engagement with any desired pipe, rod, pole, or the like.

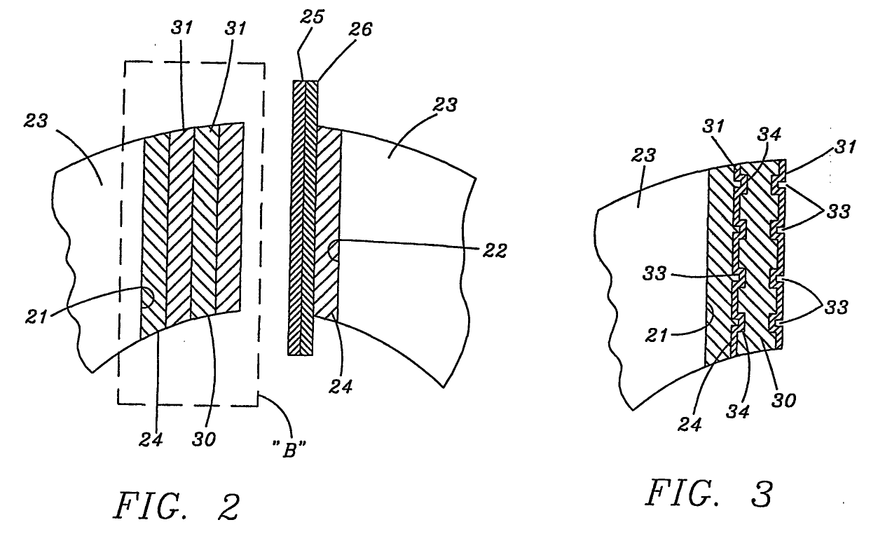

In this preferred embodiment of the present invention, pressure sensitive adhesive 24 is applied to edge 22 of thermoplastic or elastomeric tube 23, with release liner 25 mounted to pressure sensitive adhesive 24 in overlying engagement therewith. As clearly depicted in FIG. 2, release liner 25 incorporates a coating material 26, such as silicone, in order to enable release liner 25 to be easily removed from pressure sensitive adhesive 22 when desired by the user.

In the preferred embodiment, the release liner comprises one material selected from the group consisting of polyester films, polypropylene films, metallocene-based films, nylon films, metallized films, metal strips, polyethylene films, including high density polyethylene, low density polyethylene, and linear low density polyethylene, copolymer films, rubber films, fiber reinforced films and paper. Although various materials may be employed for release liner 25, a polyester film, is preferred. This overall construction is generally similar to prior art sealing systems wherein a pressure sensitive adhesive and release liner are affixed to one or both side edges of an elongated, foamed, thermoplastic or elastomeric tube.

In order to achieve the cohesive bonding provided by the present invention, side edge 21 of thermoplastic or elastomeric tube 23 incorporates a layer of pressure sensitive adhesive 24 affixed directly thereto, with intermediate substrate 30 affixed to pressure sensitive adhesive layer 24 in direct, overlying, contacting, engagement therewith. In addition, as clearly detailed in FIG. 2, in the preferred embodiment, intermediate substrate 30 incorporates a coating layer 31 of an adhesion promoting agent which is applied to both surfaces of intermediate substrate 30.

In order to enable intermediate layer 30 to provide and establish the desired cohesive bonding when interengaged with a pressure sensitive adhesive, intermediate substrate 30 is exposed to a coating of an adhesion promoter, on both sides thereof, represented in FIG. 2 as coating layers 31, 31. With the adhesion promoter coating layers 31, 31 applied to both surfaces of intermediate substrate 30, intermediate substrate 30 is able to produce a cohesive bond, whenever another adhesive, such as pressure sensitive adhesive 24, is brought into contact therewith. As a result, the application of intermediate substrate 30 to side edge 21 in contact with pressure sensitive adhesive 24, with an adhesion promoter coating layer 31 applied to substrate 30, causes cohesive bonding between the intermediate substrate 30 and edge 21 of thermoplastic or elastomeric tube 23.

Once intermediate substrate 30 is mounted to edge 21 of tube 23 in this manner, substrate 30 is permanently adhered to edge 21, with removal thereof only being possible by catastrophic damage to the foam thermoplastic or elastomeric material forming tube 23. Similarly, when release liner 25 is removed from pressure sensitive adhesive 24 of side 22 of tube 23 and pressure sensitive adhesive 24 of side 22 is brought into interengagement with coating layer 31 of an intermediate substrate 30, a second cohesive bonding is established, securely affixing side edges 21 and 22 of tube 23 together in a manner which prevents separation of the side edges without destruction of the foam thermoplastic or elastomeric material itself.

Although the actual process by which cohesive bonding is attained using the present invention may not be fully understood, the principal elements are shown in FIG. 3 and detailed herein. In this regard, it is believed that the application of adhesion promotion coating layer 31 to the surfaces of intermediate substrate 30 establishes pockets or pits 33 in coating layer 31 as well as establishing pockets or pits 34 in intermediate substrate 30 itself. These pockets or pits 33 and 34 create substantially enlarged and enhanced surface areas in which the pressure sensitive adhesive is capable of bonding when brought into contact therewith. This effect, coupled with the physical changes imparted to substrate 30 by the application of adhesion promotion coating layer 31 causes the cohesive bonding to be realized.

In carrying out the present invention, foam, thermoplastic or elastomeric tube 23 may be formed from a wide variety of different materials commonly employed for insulating tubes of this general nature. In addition, the alternate product lines detailed above in which the present invention may be employed further expand the materials on which the self-sealing, bonding/securement system of the present invention may be applied. Although the materials upon which the present invention can be employed is widely diverse, an example of the materials include one or more selected from the group consisting of polyethylenes, polypropylenes, styrene block copolymers, metallocene-based materials, polyurethanes, polystyrenes, chlorinated polyethylenes, cross-linked low density polyethylenes, copolymers such as ethylene-vinyl acetate (EVA), ethylene-butyl acrylate (EBA), and ethylene-methyl acrylate (EMA) rubber, paper, and drywall.

In addition, the adhesive employed on these substrates or base material being bonded may also be widely varied. As an example of the variety of adhesives that may be employed without departing from the scope of this invention, the adhesive may comprise one or more selected from the group consisting of pressure sensitive adhesives, hot melt adhesives, low molecular weight polymers, functionalized polymers, functionalized silicones, functionalized compounds, two component polyurethanes, two components epoxies, rubber based solvents and/or latex, polysulfides sealants/adhesives, two components acrylic based components, cyanoacrylates, and ceramics.

In addition, in accordance with the present invention, an intermediate substrate is employed to provide the desired cohesive bonding. In this regard, the intermediate substrate may be formed from a wide variety of materials. Preferably, the material employed for forming the intermediate substrate comprises one or more selected from the group consisting of polyester films, polypropylene films, metallocene-based films, nylon films, metallized films, metal strips, polyethylene films, including high density polyethylene, low density polyethylene, and linear low density polyethylene, copolymer films, rubber films, fiber reinforced films and paper. As detailed above, although polyester film is preferred, any of these other materials may be employed with equal efficacy.

As detailed above, in order to produce an intermediate substrate which is capable of providing the desired cohesive bonding, an adhesion promoter is applied to at least one surface of the intermediate substrate, and preferably both surfaces thereof. In this regard, it has been found that various materials or application processes may be employed to provide the intermediate substrate with the requisite adhesive promoting treatment. In accordance with the present invention, the desired cohesive bonding effect can be realized by employing one or more materials or processes selected from the group consisting of low molecular weight polymers, primers or paints, chemical promoters, functionalized polymers, functionalized silicones, corona or plasma applications, heat applications, UV exposure, infrared exposure, and electron beam applications. Although any of these materials or processes may be employed, it has been found that the application of low molecular weight polymers is highly effective in providing the desired result.

In applying the desired adhesive to the substrate, numerous alternate processes can be employed. In this regard, the preferred processes comprise one or more selected from the group consisting of hot melt application, lamination, coextrusion, cross head extrusion, PSA adhesion, electrical energy, and cross linking, such as electron beam and ultraviolet applications. Although each of these various processes can be effectively employed, the preferred application process comprises using hot melt application of a pressure sensitive adhesive.

Finally, a wide variety of varying release agents can be employed to enable the release liner for the pressure sensitive adhesive to be easily removed therefrom whenever application and bonding is desired. Typically, such release agents comprise one or more selected from the group consisting of silicones, Teflons, talc, calcium carbonate, and steramides. Although the use of silicones is preferred, any of these other agents may be employed to provide an effective removable strip which protects the pressure sensitive adhesive until its use is desired.

By referring to FIGS. 46, along with the following detailed discussion, the construction and operation of the second preferred embodiment of the self-sealing, bonding/securement system 20 of the present invention can best be understood as employed in this preferred application. As depicted, self-sealing, bonding/securement system 20 is affixed to edges 21 and 22 of elongated, foamed, thermoplastic or elastomeric tube 23. Edges 21 and 22 represent the juxtaposed, spaced, facing side edges formed in thermoplastic or elastomeric tube 23 by longitudinally slitting tube 23 to enable tube 23 to be mounted into peripheral surrounding engagement with any desired pipe, rod, pole, or the like.

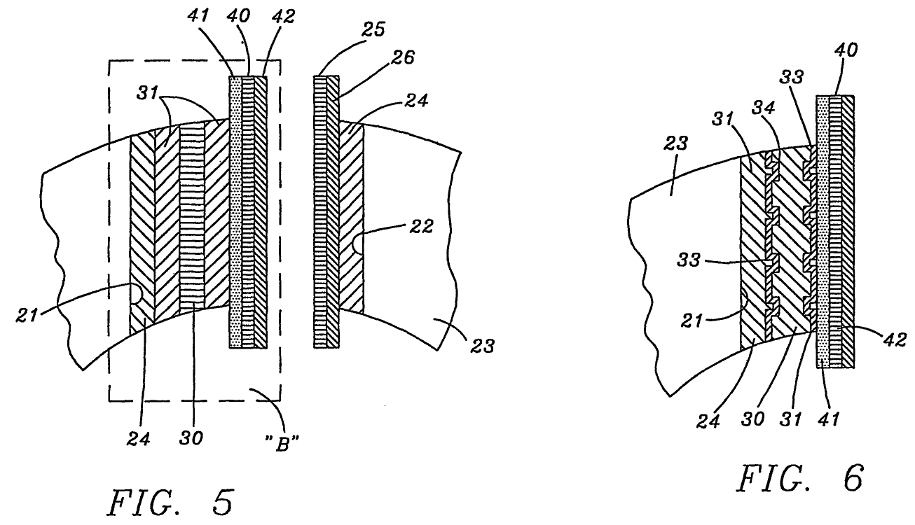

In this preferred alternate embodiment of the present invention, the construction detailed above and shown in FIGS. 1-3 is employed with pressure sensitive adhesive 24 applied to edge 22 of thermoplastic or elastomeric tube 23 and with release liner 25 mounted to pressure sensitive adhesive 24 in overlying engagement therewith. As clearly depicted in FIG. 5, and discussed above, release liner 25 incorporates a coating material 26. Preferably, the release agent comprises one or more selected from the group consisting of silicones, Teflons, talc, calcium carbonate, and steramides in order to enable release liner 25 to be easily removed from pressure sensitive adhesive 22 when desired by the user.

In the preferred embodiment, the release liner comprises one material selected from the group consisting of polyester films, polypropylene films, metallocene-based films, nylon films, metallized films, metal strips, polyethylene films, including high density polyethylene, low density polyethylene, and linear low density polyethylene, copolymer films, rubber films, fiber reinforced films and paper. Although various materials may be employed for release liner 25, a polyester film is preferred.

As discussed above, in order to achieve the cohesive bonding provided by the present invention, side edge 21 of thermoplastic or elastomeric tube 23 incorporates a layer of pressure sensitive adhesive 24 affixed directly thereto, with intermediate substrate 30 affixed to pressure sensitive adhesive layer 24 in direct, overlying, contacting, engagement therewith. In addition, as clearly detailed in FIG. 5, intermediate substrate 30 incorporates a coating layer 31 of an adhesion promoting agent which is applied to both surfaces of intermediate substrate 30.

In order to enable intermediate layer 30 to provide and establish the desired cohesive bonding when interengaged with a pressure sensitive adhesive, intermediate substrate 30 is exposed to a coating of an adhesion promoter, on both sides thereof, represented in FIG. 5 as coating layers 31, 31. With the adhesion promoter coating layers 31, 31 applied to both surfaces of intermediate substrate 30, intermediate substrate 30 is able to produce a cohesive bond, whenever another adhesive, such as pressure sensitive adhesive 24, is brought into contact therewith. As a result, the application of intermediate substrate 30 to side edge 21 in contact with pressure sensitive adhesive 24, with an adhesion promoter coating layer 31 applied to substrate 30, causes cohesive bonding between the intermediate substrate 30 and edge 21 of thermoplastic or elastomeric tube 23.

Once intermediate substrate 30 is mounted to edge 21 of tube 23 in this manner, substrate 30 is permanently adhered to edge 21, with removal thereof only being possible by catastrophic damage to the foam thermoplastic or elastomeric material forming tube 23. Similarly, when release liner 25 is removed from pressure sensitive adhesive 24 of side 22 of tube 23 and pressure sensitive adhesive 24 of side 22 is brought into interengagement with coating layer 31 of an intermediate substrate 30, a second cohesive bonding is established, securely affixing side edges 21 and 22 of tube 23 together in a manner which prevents separation of the side edges without destruction of the foam thermoplastic or elastomeric material itself.

As detailed above, it is believed that the application of adhesion promotion coating layer 31 to the surfaces of intermediate substrate 30 establishes pockets or pits 33 in coating layer 31 as well as establishing pockets or pits 34 in intermediate substrate 30 itself. These pockets or pits 33 and 34 create substantially enlarged and enhanced surface areas in which the pressure sensitive adhesive is capable of bonding when brought into contact therewith. This effect, coupled with the physical changes imparted to substrate 30 by the application of adhesion promotion coating layer 31 causes the cohesive bonding to be realized.

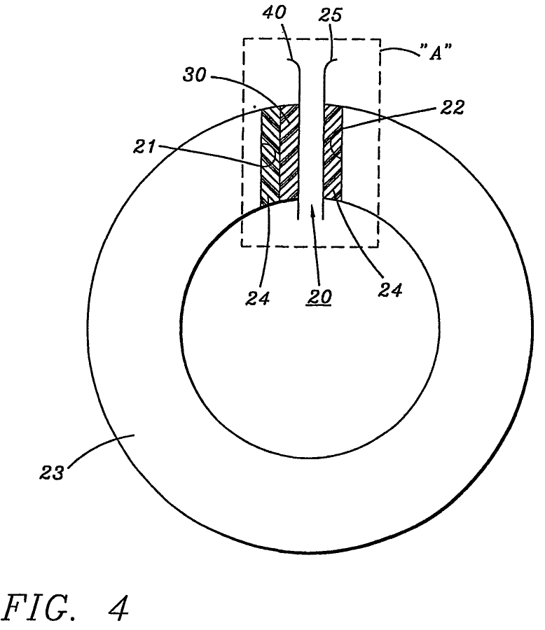

It has been found that in some applications the exposed surface of the intermediate substrate 30 can become soiled during the installation process. As a result, in the alternate embodiment shown in FIGS. 4-6, a second release liner 40 is employed. However, as is evident from the foregoing detailed disclosure, care must be exercised in employing an adhesive for affixing release liner 40 to intermediate substrate 30 in order to prevent a cohesive bonded interengagement from being established between these two components.

As depicted in FIGS. 5 and 6, release liner 40 comprises adhesive coating 41 affixed thereto which is specially constructed for enabling release liner 40 to be removably mounted to intermediate substrate 30. In this regard, a low tack adhesive is preferably employed. In addition, in the preferred embodiment, adhesive coating 41 is applied to the surface of release liner 40 in a predefined pattern, with the pattern incorporating a plurality of void zones or void areas. It has been found that the ratio of void areas to adhesive covered areas preferably ranges between about 25:75 to 75:25. By combining a low tack adhesive and a plurality of areas or zones which are devoid of any adhesive, the complete removability of liner 40 from intermediate substrate 30 is achieved without any difficulty or complication.

In the preferred embodiment, release liner 40 is formed from a film selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films, and paper. Furthermore, adhesive coating 41 preferably comprises a low tack adhesive selected from the group consisting of pressure sensitive adhesives, water-based adhesives, acrylic adhesives, water-based acrylic pressure sensitive adhesives, hot melt adhesives, rubber based adhesives, and silicone based adhesives. In addition, if desired, a static charge can be employed instead of an adhesive for securing release liner 40 to intermediate substrate 30, as well as using heat reactive material for attaining the desired removable engagement of release liner 40 to intermediate substrate 30.

As shown in FIGS. 5 and 6, release liner 40 also comprises a coating 42 which is preferably employed, but which is not mandatory for the efficacious use of the present invention. In this regard, coating 41 preferably comprises a release agent comprising one or more selected from the group consisting of silicones, Teflons, talc, calcium carbonate, and steramides.

Although the use of coating layer 42 on release liner 40 is not mandatory, it has been found that the incorporation of coating 42 to release liner 40 on the surface opposed from adhesive 41 is desirable in order to prevent unwanted affixation of adhesive 24 to the uncoated surface of release liner 40 if release liner 25 is removed prior to the removal of release liner 40.

Although the removal of release liner 25 and release liner 40 substantially simultaneously is preferred, or the removal of release liner 40 prior to release liner 25, instances have occurred where release liner 25 is removed before release liner 40 is removed. In these instances, uncoated exposed surfaces of release liner 40 have been brought into contact with adhesive 24 causing a bond to be formed therebetween. As result, by applying coating 42 to the otherwise exposed surface of release liner 40, any unwanted accidental affixation of adhesive 24 to release liner 40 is eliminated.

In order to apply the self-sealing, bonding/securement system of the present invention to an elongated, thermoplastic or elastomeric tube, generally conventional in-line or off-line processes may be employed with minimum modification. For exemplary purposes, the application of the bonding system of the present invention in an in-line process to a low-density polyethylene foam tube is detailed herein.

First, the low-density polyethylene foam tube is extruded in a conventional process for manufacturing pipe insulation material. After passing through a brief cooling process, the foam tube enters a slitter which produces the continuous, longitudinal slit in the tube. Then, after exiting the slitter, the foam tube enters the inline gluing process, where the adhesive, usually a pressure sensitive adhesive, the release film and the intermediate substrate are affixed to the inside edges of the foam tube.

Upon exiting the in-line glue process, the product is cut to length and loaded into a forced-air cooling elevator. The product spends upward of 10 minutes in the cooling elevator, depending upon line speed, before the product is unloaded from the elevator and packaged for shipment.

In the in-line gluing process employed in the present invention to position the self-sealing bonding/securement system of the present invention to the side edges of the elongated, thermoplastic or elastomeric tube, the application system is constructed with two separate feed lines simultaneously delivering material to opposed edges of the thermoplastic or elastomeric tube. In this regard, one feed line delivers the release liner, with the release agent previously applied thereto, while the other feed line delivers the intermediate substrate, onto which the adhesion promoter coating layer has previously been applied.

In order to affix these two separate and independent feed lines directly to a side edge of the foam, thermoplastic or elastomeric tube, two separate and independent glue applicators are employed, with one glue applicator being associated with each feed line. In the preferred embodiment, a pressure sensitive adhesive is applied directly to one surface of each feed line using a hot melt application technique. In this regard, the glue is applied preferably at about 350° degrees F., and then is rapidly transported directly onto the side edge of the foam tube. In the preferred process, the hot melt pressure sensitive adhesive is applied and affixed to the side edge of the foam tube in less than one second.

By employing this process, the release liner, with its release agent, and pressure sensitive adhesive are affixed directly to one side edge of the foam tube. In addition, simultaneously therewith, the intermediate substrate, with its adhesion promoter layers on both surfaces thereof, and pressure sensitive adhesive on one surface thereof are affixed to the second side edge of the foam tube. Once the hot melt pressure sensitive adhesive has been absorbed into the foam material forming the side edges thereof, these two separate and independent components are securely affixed to the foam, thermoplastic or elastomeric tube, ready for use when desired.

It will thus be seen that the object set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desire to secure by Letters Patent is:

1. A self-sealing, pressure-sensitive, secure bonding system for affixing free edges or surfaces of a member in a manner which prevents separation of the edges or surfaces without degradation of the member, said bonding system comprising:
A. adhesive layers affixed along two juxtaposed, facing free edges or surfaces of the member, and
B. an intermediate, cohesive-bond forming substrate
a. affixed to at least one of said adhesive layers affixed to the two juxtaposed, facing free edges or surfaces, and
b. comprising at least one surface having an adhesion promoting agent applied thereto;
whereby a bonding system is realized which establishes a separation resistant, cohesive bond between the edges or surfaces of the member whenever said edges or surfaces are brought into engagement with each other.

2. The bonding system defined in claim 1, wherein the application of the adhesion promoting agent to the intermediate substrate produces a plurality of pockets or pits in the surface of the intermediate substrate or the adhesion promoting agent, forming a cohesive bond therewith.

3. The bonding system defined in claim 2, wherein the adhesion promoting agent is applied to opposed surfaces of the intermediate member, thereby producing a cohesive bond on both surfaces thereof.

4. The bonding system defined in claim 1, wherein the intermediate substrate is further defined as comprising one selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper.

5. The bonding system defined in claim 4, wherein the adhesion promoting agent comprises one selected from the group consisting of low molecular weight polymers, primaries, paints, chemical promoters, functionalized polymers, functionalized silicones, corona applications, plasma applications, heat applications, UV exposure, infrared exposure, and electron beam applications.

6. The bonding system defined in claim 5, wherein the plastic-based member is further defined as comprising one selected from the group consisting of polyethylenes, polypropylenes, styrene block copolymers, metallocene-based materials, polyurethanes, polystyrenes, chlorinated polyethylenes, cross-linked low density polyethylenes, copolymers, rubber, paper, and drywall.

7. The bonding system defined in claim 6, wherein said adhesive layer comprises at least one selected from the group consisting of pressure sensitive adhesives, hot melt adhesives, low molecular weight polymers, functionalized polymers, functionalized silicones, functionalized compounds, two components polyurethanes, two component epoxies, rubber based solvents, latex based solvents, polysulfide sealants/adhesives, two components acrylic based components, cynoacrylates, and ceramics.

8. The bonding system defined in claim 6, wherein said system further comprises:
C. a first release liner removably mounted to the adhesive layer affixed along one of said juxtaposed, facing, free edges for protecting the adhesive layer and enabling access to the adhesive layer when desired by removal of said liner.

9. The bonding system defined in claim 8, wherein said release liner is formed from a film selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper and comprises a coating of silicone formed thereon, enabling the easy removal of said release liner from the adhesive layer, without any degradation of the adhesive layer.

10. The bonding system defined in claim 8, wherein said system further comprises:
D. A second release liner removably mounted to the intermediate substrate for protecting the exposed surface of the substrate until ready for use.

11. The bonding system defined in claim 10, wherein said second release liner is formed from a film comprising one selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper.

12. The bonding system defined in claim 11, wherein a first surface of the film comprises a silicone coating and a second surface comprises a low tack adhesive constructed for being mounted to the intermediate substrate for protecting the surface thereof while also being easily removed from the substrate when desired.

13. The bonding system defined in claim 12, wherein said low tack adhesive is further defined as being applied to the surface of the intermediate substrate in a pattern which comprises a plurality of void areas.

14. The bonding system defined in claim 13, wherein said low tack adhesive comprises one selected from the group consisting of pressure sensitive adhesives, hot melt adhesives, solvent based acrylics, water based acrylics, solvent based rubbers, and functionalized silicones.

15. A multipurpose, easily sealable, substantially continuous, elongated tube assembly incorporating a self-sealing, pressure sensitive, secure bonding system for affixing the free edges of the tube member in a manner which prevents separation of the edges without degradation of the plastic material forming the tube member, said tube assembly comprising
E. an elongated, hollow, generally cylindrically shaped tube member
A. formed from thermoplastic or elastomeric materials, and
B. incorporating a longitudinally extending slit formed therein, forming two free edges which enable said elongated tube member to be mounted about a continuous, elongated cylindrical surface for peripherally surrounding and enveloping said elongated cylindrical surface;
F. adhesive layers formed on the cylindrically shaped tube member in cooperating relationship with each of the two free edges of the tube member; and
G. an intermediate, cohesive-bond forming a substrate
A. affixed to at least one of the adhesive layers associated with the free edges of the tube member, and
B. comprising at least one surface having an adhesion promoting the agent applied thereto;
whereby a tube assembly is realized having a bonding system formed thereon which establishes a separation resistant, cohesive bond between the edges of the tube member whenever the edges are brought into engagement with each other.

16. The tube assembly defined in claim 15, wherein the adhesion promoting agent is applied to opposed surfaces of the intermediate member, thereby producing a cohesive bond on both surfaces thereof.

17. The tube assembly defined in claim 15, wherein the intermediate substrate is further defined as comprising one selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper.

18. The tube assembly defined in claim 17, wherein the adhesion promoting agent comprises one selected from the group consisting of low molecular weight polymers, primaries, paints, chemical promoters, functionalized polymers, 110 fictionalized silicones, corona applications, plasma applications, heat applications, UV exposure, infrared exposure, and electron beam applications.

19. The tube assembly defined in claim 18, wherein the tube member is further defined as comprising one selected from the group consisting of polyethylenes, polypropylenes, styrene block copolymers, metallocene-based materials, polyurethanes, polystyrenes, chlorinated polyethylenes, cross-linked low density polyethylenes, copolymers, ethylene-vinyl acetate, ethylene-butyl acrylate, ethylene-methyl acrylate, and rubbers.

20. The tube assembly defined in claim 15, wherein said assembly further comprises:
C. a first release liner removably mounted to the adhesive layer affixed along one of said juxtaposed, facing, free edges for protecting the adhesive layer and enabling access to the adhesive layer when desired by removal of said liner.

21. The tube assembly defined in claim 20, wherein said release liner is formed from a film selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper and comprises a coating of silicone formed thereon, enabling the easy removal of said release liner from the adhesive layer, without any degradation of the adhesive layer.

22. The tube assembly defined in claim 20, wherein said system further comprises:
D. a second release liner removably mounted to the intermediate substrate for protecting the exposed surface of the substrate until ready for use.

23. The tube assembly defined in claim 22, wherein said second release liner is formed from a film comprising one selected from the group consisting of polyester films, polypropylene films, metallocene-based films, nylon films, metallized films, metal strips, polyethylene films, high-density polyethylene films, low density polyethylene films, linear low density polyethylene films, copolymer films, rubber films, fiber reinforced films and paper.

24. The tube assembly defined in claim 23, wherein a first surface of the film comprises a silicone coating and a second surface comprises a low tack adhesive constructed for being mounted to the intermediate substrate for protecting the surface thereof, while also being easily removed from the substrate when desired.

25. The tube assembly defined in claim 24, wherein said low tack adhesive is further defined as being applied to the surface of the intermediate substrate in a pattern which comprises a plurality of void areas.

26. The tube assembly defined in claim 25, wherein said low tack adhesive comprises one selected from the group consisting of pressure sensitive adhesives, hot melt adhesives, water based acrylics, solvent based acrylics, solvent based rubbers, and functionalized silicones.
